(19) United States
(12) Patent Application Publication
(10) Pub. No.: US 2013/0154898 A1
(43) Pub. Date: Jun. 20, 2013

(54) ANTENNA CONFIGURATION METHOD AND APPARATUS

(71) Applicant: Magellan Technology Pty Ltd., Annandale (AU)

(72) Inventor: Stuart Colin LITTLECHILD, Haberfield (AU)

(73) Assignee: Magellan Technology Pty Ltd., Annandale (AU)

(21) Appl. No.: 13/768,479

(22) Filed: Feb. 15, 2013

Related U.S. Application Data
(63) Continuation of application No. 13/745,764, filed on Jan. 19, 2013.
Application No. 13/745,764 is a continuation of application No. PCT/AU2011/001101, filed on Jul. 20, 2011.

(30) Foreign Application Priority Data
Jul. 21, 2010 (AU) 2010903263

(51) Int. Cl. H01Q 21/00; G06K 19/077; H01Q 7/00

(52) U.S. Cl. CPC H01Q 21/00; H01Q 7/00; G06K 19/07773
USPC 343/867; 343/866; 235/492

(57) ABSTRACT

The present invention relates to the field of data transmission. In one form, the invention relates to the transmission and/or reception of data modulated signals between various devices, including loads and/or antennas. In another form, the invention relates to the field of transponders (tags), such as Radio Frequency Identification Devices (RFID), interrogator devices/systems and the transmission of data between a tag and an interrogator. The present invention utilises antenna design to alleviate tag coupling.

### FIELD OF INVENTION

The present invention relates to the field of data transmission. In one form, the invention relates to the transmission and/or reception of data modulated signals between various devices, including loads and/or antennas.

In another form, the invention relates to the field of transponders (tags), such as Radio Frequency Identification Devices (RFID), interrogator devices/systems and the transmission of data between a tag and an interrogator.

It will be convenient to hereinafter describe the invention in relation to transmission between a RFID tag and an interrogator, however it should be appreciated that the present invention is not limited to that use only.

### BACKGROUND ART

Throughout this specification the use of the word “inventor” in singular form may be taken as reference to one (singular) inventor or more than one (plural) inventor of the present invention.

One common use of tags is to adhere a tag to a certain item so the item can be traced and/or information regarding the item can be interrogated when needed. One such use of tags is on postal items, such as parcels, boxes and/or envelopes. In this case, often tags with adhesive backing are adhered to an item such as a box. It has been observed by the inventors that a number of boxes are usually co-located in an area, truck or conveyor belt and thus when undergoing interrogation of a particular tag, there are a number of items also in close proximity of the tag being interrogated. A problem can arise when at least two boxes are found to be close together. A tag located on one item may come into close contact with another tag on another item. Note that in this situation the topsides (non adhesive sides) of the tags face each other. If this situation occurs, it has been observed that the tags may effectively interact and substantially interfere or even cancel each other's reply. It has been determined that when two tags are placed relatively close together, the resonant frequency of the combined tags can be close to or equal to the tag reply frequency.

For example, some tags in use generate replies at around 15.5 MHz. Typically individual stackable tags have a resonant frequency of 25 MHz or higher. The resonant frequency is function of the RFID chip (stray) capacitance, tag antenna stray capacitance and the tag antenna inductance. As two tags are brought close together, the resonate frequency of the combined tags reduces below the resonant frequency of the individual tags. This reduction in the resonant frequency is due to additional stray capacitance between the tags and mutual inductance. It is possible, especially if the initial antenna inductance is relatively high enough and the tags are placed relatively close enough, that the resonate frequency of the ‘combined’ tags ends up at or near the tag reply frequency.

In this situation, it has been observed that reply signals from one tag will couple to the other tag. If tag reply frequency is at the resonant frequency of the combined tags, then this coupling will be very strong. A tag replies by generating a changing magnetic field. Thus, any other closely located tag will produce an opposing magnetic field. If the coupling between the tags is relatively strong, then the magnetic field generated by the replying tag will be substantially reduced or cancelled by the other tag. Thus, the inventors have realised that in certain applications, tag replies can become weak and therefore difficult to receive.

One solution is to move the resonant frequency away from the tag reply frequency. However, this is not always practical. The inventors have realised that it is possible to reduce the coupling between the tags and thus increase the resonant frequency of the combined tags away from the reply frequency, for example by lowering:
the individual tag antenna inductance
the individual tag antenna stray capacitance
the mutual inductance of the combined tags, and/or
the stray capacitance between the tags

The individual tag inductance can be lowered by either:
using less tag antenna turns—which results in a smaller collecting area and thus decrease the operating range of the tag
or a larger tag with less turns
   However, neither of these alternatives is considered acceptable.

The individual tag stray capacitance can be reduced by increasing the gap between antenna turns. This will decrease the collecting area and thus decrease the operating range of the tag which is also not considered acceptable.

The mutual inductance and the stray capacitance between the tags can be reduced by keeping the tags apart; however this not practical as it is not always possible to control the orientation and positioning of items, especially postal items and thus this proposal is not considered to suit all applications.

In other applications, the Item to which a tag is adhered, such as casino chip, has a relatively shallow recess provided to accommodate the tag in a manner some distance away from an outer edge of the casino chip. This impedes design of tags, antennas and items to which tags are adhered.

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the Inventor's knowledge and experience and, accordingly, any such discussion should not be taken as an admission that any of the material. forms part of the prior art base or the common general knowledge in the relevant art in Australia, or elsewhere, on or before the priority date of the disclosure and claims herein.

### SUMMARY OF INVENTION

An object of the present invention is to provide an improved tag and 1 or method of data transmission.

A further object of the present invention is to alleviate at least one disadvantage associated with the related art.

It is an object of the embodiments described herein to overcome or alleviate at least one of the above noted drawbacks of related art systems or to at least provide a useful alternative to related art systems.

In a first aspect of embodiments described herein there is provided a tag comprising an antenna having a first portion having a first configuration and a second portion having a second configuration, first configuration being different than the second configuration.

In another aspect of embodiments described herein there is provided a tag comprising an antenna having a first configuration such that when placed in a face to face orientation with another tag having an antenna of a second configuration, the first configuration is not a mirror image of the second configuration.

In yet a further aspect of embodiments described herein there is provided a communication system comprising a first device having a first antenna, a second device having a second antenna, at least one of the first and second antennas having a first portion having a first configuration and a second portion having a second configuration, first configuration being different than the second configuration.

In another aspect of embodiments described herein there is provided a method of reducing interference between a first antenna and a second antenna, the method comprising providing the first antenna in a first shape, providing the second antenna in a second shape, the first shape being different to the second shape.

In another aspect of embodiments described herein there is provided a method of configuring an antenna adapted to reduce mutual coupling with another antenna, the method comprising configuring the antenna to have a relatively non-symmetrical shape.

In another aspect of embodiments described herein there is provided a method of configuring an antenna adapted for use with a tag, the method comprising providing an antenna having a first configuration such that when placed in a face to face orientation with another antenna of a second configuration, the first configuration is not a mirror image of the second configuration.

Other aspects and preferred forms are disclosed in the specification and/or defined in the appended claims, forming a part of the description of the invention.

In essence, embodiments of the present invention stem from the realization that a relatively non-symmetrical antenna design may be used to alleviate tag coupling. In this regard, the present Invention contemplates providing an antenna having at least two portions, the first portion having a first shape and the second portion having a second shape, different from the first shape. In one embodiment, the first portion is not a mirror image of the second portion different. In another embodiment, the first and second portions may have a substantially similar area, but each still has a different shape.

It is preferable that the lack of symmetry is relative to at least two axis.

Furthermore, providing one tag having a first antenna with a first shape, and another tag having a second antenna with a second shape, the first and second shaped antennas having a different shape to each other, has been observed to alleviate undesirable tag coupling. In one form, if a number/plurality of tag(s) have antenna(s) that are of a different (even random) shape, then coupling causing interference will be reduced. It has also been determined that even a relatively small difference in shape between one antenna and another antenna is enough to alleviate interference between tags.

Advantages provided by the present invention comprise the following:
Reduced coupling between proximate antennas;
One antenna has an Increased position insensitivity relative to another antenna;
Enables a number of tags/antennas to be used in relatively close or confined situations/applications;
Alleviates the need for an item to have a recess to incorporate a tag.

Throughout this specification, ‘tag’ is intended to include, without limitation, an RFID device comprising a microchip placed on a powering, transmitting and/or receiving antenna carried on a substrate (inlay) and that is powered externally by an inductive field or by a battery. It also includes a token, insert, transponder, chip, label, identification device, badge, inlet, inlay, ticket, wireless memory or any other form of identifiable device and may be rendered in any technology which enables identification. For example, the tag may be an RFID tag. In a further example, and without limitation, the identification device may be an ASIC, other microchip, an ASIC with an associated antenna assembly, or an antenna without a chip where electronic circuitry included in the printed antenna structure, provides the intelligence of the device, logic means or is a tuned antenna.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 illustrates a prior art symmetrical tag;

FIG. 2 illustrates a non symmetrical antenna design in accordance with an embodiment of the present invention;

FIG. 3 illustrates another non symmetrical antenna design in accordance with another embodiment of the present invention;

FIG. 4 illustrates shows two over lapping prior art antennas;

FIG. 5 illustrates two over lapping simplified non symmetrical antennas in accordance with an embodiment of the present invention; and

FIG. 6 illustrates another two over lapping simplified alternative non symmetrical antennas in accordance with another embodiment of the present invention.

### DETAILED DESCRIPTION

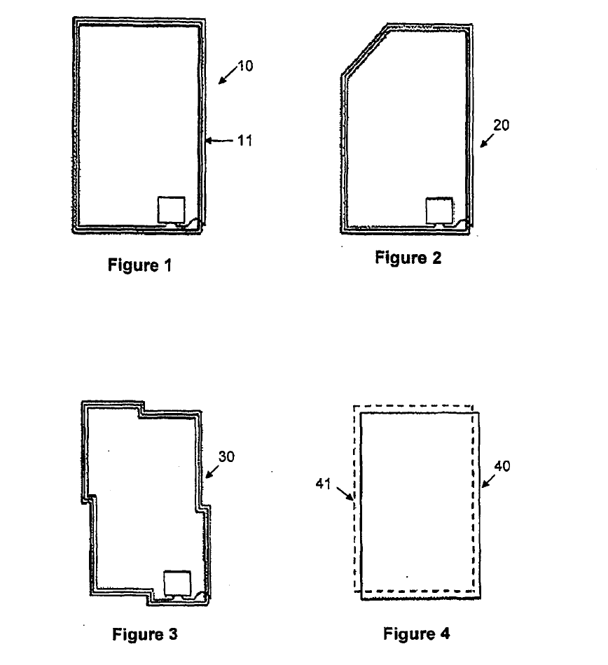

FIG. 1 Illustrates a prior art tag 10. The antenna 11 has a relatively symmetrical shape, at least a symmetry about one axis. When a prior art tag 10 as shown in FIG. 1 is placed in a face to face relationship with another, similar, tag the positioning of the tags will be as represented in FIG. 4. In FIG. 4, although each tag antenna 40 and 41 (as represented by dotted and solid lines respectively) is made up of a number of turns, for the sake of ease of understanding of the present invention, these turns are represented in FIG. 4 by a single line (solid or dotted). Also, for clarity the antennas 40 and 41 have been drawn slightly misaligned, so the shape of each antenna can be discerned. It can be seen that the antenna of one tag 40 is aligned with antenna 41 of another tag, when the two antennas are placed face to face with each other. Tags that use symmetrical antenna designs can be aligned so one tag antenna sits directly or closely on top of the next tag antenna. This means that the antenna turns for the two tags overlap and are thus very close to each other. In operation, this results in a high mutual inductance and high stray capacitance between the antennas 40 and 41, and thus interference.

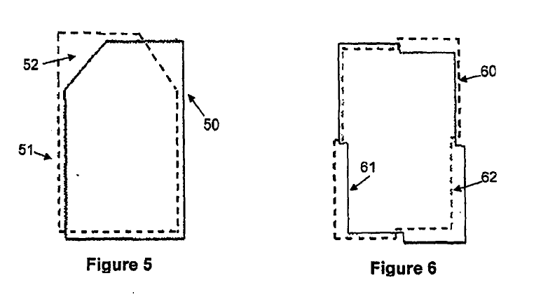

FIGS. 2 and 3 show examples of antenna designs 20 and 30 according to the present invention. The antennas are shaped so that, when placed face to face with a corresponding antenna of a similar shape, there is reduced interference. This is illustrated in FIGS. 5 and 6.

FIG. 5 shows two over lapping simplified non symmetrical antennas 50 and 51. These antennas 50 and 51 are illustrated face to face (topside to topside or bottom side to bottom side). Again these antennas have been draw slightly misaligned for the sake of clarity. Unlike the symmetrical antennas illustrated in FIGS. 1 and 4, the antennas according to the present invention, when placed face to face, do not substantially align with each other. That is, at least one area 52 is provided in which the antennas do not overlap. This results in a reduced mutual inductance and stray capacitance between the antennas. In other words, the antenna shape according to the present invention is configured in such a way that two antennas 51 and 51 cannot be positioned so that the antennas turns substantially cover or align with each other. It may be said that the antenna configuration of the present invention provides an asymmetric antenna shape.

FIG. 6 shows another example of two over lapping simplified alternative non symmetrical antennas 60 and 61. Again the antennas are illustrated in a face to face alignment. Again, the antennas are shaped so that a region 62 is provided in which the antennas do not overlap.

In applications where tags according to the present invention are stuck on to items including boxes, the boxes can be stored such that the tags are perfectly or closely aligned and touch or almost touch, face to face, topside to topside or bottom side to bottom side. In this position, it has been found that, whereas in the prior art, there is relatively strong coupling between the tags and thus the possibility of weak replies, In the present invention, with the use of tags having antennas of a different shape and/or a non symmetrical antenna design, the coupling between the tags will be reduced.

The solution to this problem, which we want to patent, is to use a non-symmetrical tag antenna design. In this application tags are stuck on to items including boxes. The boxes can be stored such that the tags are perfectly or closely aligned and touch or almost touch, topside to topside. In this position there is strong coupling between the tags and thus the possibility of weak replies. If a non symmetrical antenna design is used the coupling between the tags will be reduced.

The present invention is applicable, at least, to RFID antenna(s).

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

1-17. (canceled)

18. An antenna comprising:
a first portion having a first configuration and arranged substantially in a first plane of a plurality of planes;
a second portion exclusive to and connected to the first portion, having a second configuration, and arranged substantially in the first plane;
wherein the first portion and the second portion are divisible by a second plane of the plurality of planes, the second plane being perpendicular to the first plane; and
wherein the first configuration and the second configuration are not minor images of one another when reflected about an axis formed by intersection of the first plane and any possible orientation of the second plane.

19. A tag comprising:
an antenna having a first configuration in a first plane;
wherein, when the antenna is placed in a face-to-face orientation with another tag having an antenna of a second configuration in a second plane, the first configuration is not a minor image of the second configuration; and
wherein the first plane and the second plane are substantially parallel to one another.

20. The tag as claimed in claim 19, wherein the first configuration is not a minor image of the second configuration in a plurality of antenna orientations.

21. The tag as claimed in claim 20, wherein the first configuration is not a minor image of the second configuration in all possible antenna orientations.

22. The tag as claimed in claim 19, wherein the first configuration and the second configuration are the same.

23. The tag as claimed in claim 19, wherein the tag is an RFID tag.

24. A communication system comprising:
a first device comprising a first antenna;
a second device comprising a second antenna;
wherein each of the first antenna and the second antenna comprises:
a first portion having a first configuration in a plane; and
a second portion having a second configuration in the plane;
wherein the first configuration is different from the second configuration such that, when the first antenna and the second antenna are placed in a face-to-face configuration, the first antenna and the second antenna are not mirror images of one another.

25. An antenna-configuration method comprising:
configuring a first antenna to have a relatively non-symmetrical shape in a first plane;
configuring a second antenna to have the same shape as the first antenna in a second plane;
wherein, when the first antenna and the second antenna are placed in a face-to-face configuration and the first plane and the second plane are parallel to one another, mutual coupling between the first antenna and the second antenna is reduced relative to a first antenna and a second antenna having a same relatively symmetrical shape.

26. The method as claimed in claim 25, wherein the configuration of the first antenna and the second antenna reduces interference between the first antenna and the second antenna.

27. The method as claimed in claim 25, wherein, when the first antenna and the second antenna are placed in any face-to-face orientation, the first configuration is not a minor image of the second configuration.
